(19) United States
(12) Patent Application Publication
(10) Pub. No.: US 2011/0173086 A1
(43) Pub. Date: Jul. 14, 2011

(54) Systems and Methods for Dynamic Pricing and Auction Adjudication During Online Auctions

(76) Inventor: Ed BERKOWITZ, Redwood City, CA (US)

(21) Appl. No.: 12/968,079

(22) Filed: Dec. 14, 2010

Related U.S. Application Data
(60) Provisional application No. 61/286,276, filed on Dec. 14, 2009.

(51) Int. Cl. G06Q 30/00

(52) U.S. Cl. 705/26.3

(57) ABSTRACT

An electronic auction system hosting an auction includes a pricing and an adjudication application. The pricing application adjusts an opening price of an auction item to be less than a reserve price in response to buyer interest factors. The adjudication application receives bids on the item and automatically evaluates a reserve price and, when determining the reserve price is too high, adjusts the reserve price to an adjusted reserve price when a highest bid is less than the reserve price. When the adjusted reserve price is equal to or less than the highest bid the adjudication application automatically awards the item to a high bidder. When the adjusted reserve price is greater than the highest bid the adjudication application automatically sends an electronic message to the high bidder to inform that the reserve price has been adjusted and to inform of their status as high bidder.

### RELATED APPLICATIONS

This application claims the benefit of U.S. patent application Ser. No. 61/286,276, filed Dec. 14, 2009.

This application is related to U.S. patent application Nos. 11/457,068, 11/457,074, 11/457,077, 11/681,727, 11/681,729, 11/685,120, 11/685,121, 12/714,960, 12/748,258, 12/796,436, 12/892,590, and 61/328,921.

### TECHNICAL FIELD

Embodiments are described relating to electronic auction systems and, more particularly, to dynamic pricing and auction adjudication using the electronic auction systems.

### BACKGROUND

The typical online seller (consignor) pricing process has been less flexible than the physical auction process. In this typical online approach, where bidding starts at a pre-specified reserve price (set in advance to estimate a “market price”), there is no opportunity to sell a vehicle for any amount below the reserve price. Given the complexity of pricing and distribution of prices around the average, experience with online auctions suggests sale prices in general are less or more than the “market price” in almost every case and, further, are less than the “market price” in approximately half the cases, which cannot be serviced in the traditional auction approach.

### INCORPORATION BY REFERENCE

Each patent, patent application, and/or publication mentioned in this specification is herein incorporated by reference in its entirety to the same extent as if each individual patent, patent application, and/or publication was specifically and individually indicated to be incorporated by reference.

### BRIEF DESCRIPTION OF THE DRAWINGS

FIG. 1 is a block diagram of an electronic auction system comprising dynamic pricing and If-bidding auction adjudication, under an embodiment.

FIG. 2 shows six iterations of an example vehicle auction lifecycle using dynamic pricing, under an embodiment.

FIG. 3 shows six iterations of another example vehicle auction lifecycle using dynamic pricing, under an embodiment.

FIG. 4 is a flow diagram of If-bidding auction adjudication, under an embodiment.

FIG. 5 is an example electronic mail sent to the high bidder by the If-bidding component, under an embodiment.

FIG. 6 is an example BID REVIEW interface of the If-bidding, under an embodiment.

FIG. 7 is an example BID REVIEW interface of the If-bidding, under an alternative embodiment.

FIG. 8 is an example page that displays indications of which vehicles correspond to adjusted pricing, under an embodiment.

FIG. 9 is an example page that displays indications of which vehicles correspond to adjusted pricing, under an alternative embodiment.

FIG. 10 is an example page that displays indications of which vehicles correspond to adjusted pricing, under an alternative embodiment.

### DETAILED DESCRIPTION

An electronic auction system hosting an auction includes a pricing and an adjudication application. The pricing application adjusts an opening price of an auction item to be less than a reserve price in response to buyer interest factors. The adjudication application receives bids on the item and automatically evaluates a reserve price and, when determining the reserve price is too high, adjusts the reserve price to an adjusted reserve price when a highest bid is less than the reserve price. When the adjusted reserve price is equal to or less than the highest bid the adjudication application automatically awards the item to a high bidder. When the adjusted reserve price is greater than the highest bid the adjudication application automatically sends an electronic message to the high bidder to inform that the reserve price has been adjusted and to inform of their status as high bidder.

In the following description, a number of features are described in detail in order to provide a more thorough understanding of the embodiments described herein. It is apparent that these embodiments may be practiced without these specific details. In other cases, well known features have not been described in detail.

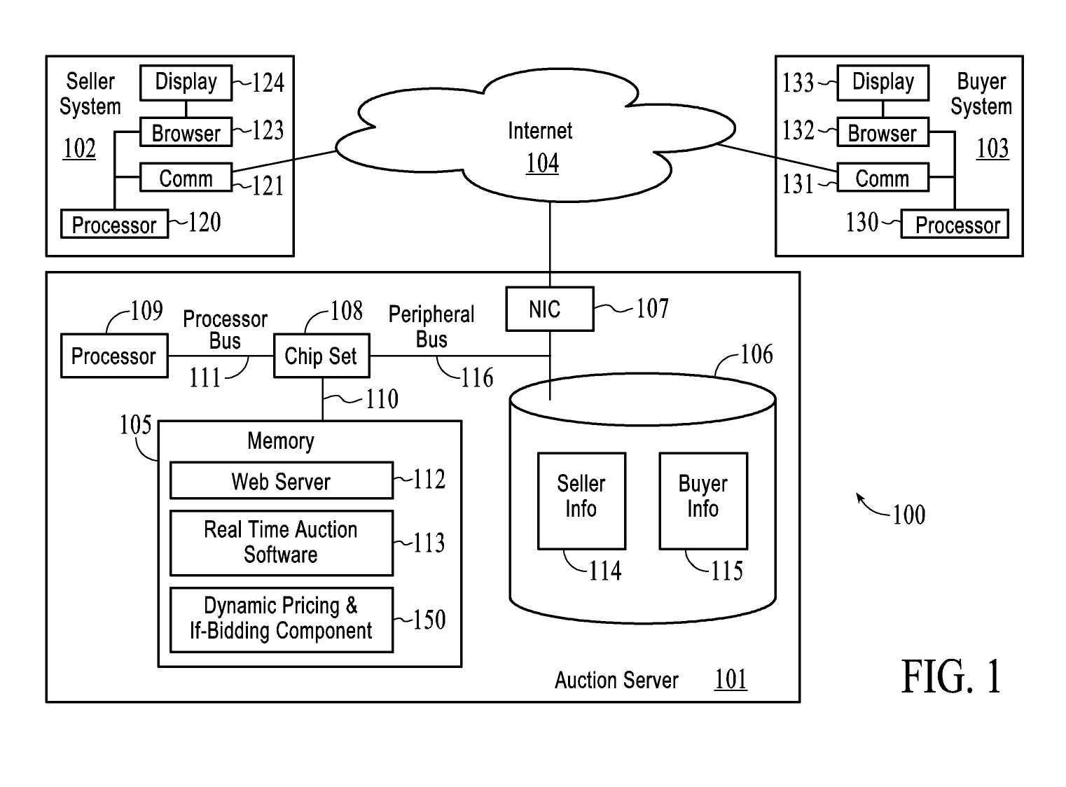

FIG. 1 is a block diagram of an electronic auction system comprising dynamic pricing and If-bidding auction adjudication, under an embodiment. The equipment of an embodiment includes motor vehicles, but the auction system 100 is not limited to motor vehicles. Other tools and network configurations may be used according to other embodiments. In the system 100 shown are auction server 101, seller system 102, and buyer system 103. Auction server 101 is coupled to seller system 102 and buyer system 103 through Internet 104. Auction sever 101 may include a processor 109 for processing instructions, such as an Intel Pentium™ processor, AMD Athlon™ processor or other processor. Processor 109 is coupled to chip set 108 by a processor bus 111. Chip set 108 is coupled to memory 105 by a memory bus 110 and manages access to memory 105 by processor 109. Chip set 108 is also coupled to peripheral bus 116. Peripheral 116 bus can comprise, for example, PCI, PCI-X, PCI Express, or other peripheral bus. Auction server 101 also includes one or more network interface cards 107 coupled to peripheral bus 116 for providing network interfaces to network, such as Internet 104. Storage 106, such as a disk array or other non-voltage storage, is also coupled to peripheral bus 116.

According to various embodiments, memory 105 and/or storage 106 may include various forms of storage or computer-readable memories such as, but not limited to, volatile memory (random access memory (RAM), non-volatile memory (read-only memory (ROM)), EEPROM, disk, and/or other storage devices that may include one or more of magnetic, optical storage, or other media. The memory and/or storage on the auction server may be configured as a Redundant Array of Independent Disks (RAID) configuration to provide high reliability access to software and data.

Software may be loaded into memory 105 to help provide dynamic pricing and If-bidding support for auction server 101. For example, web server 112, real-time auction component 113, and the dynamic pricing and If-bidding component 150 can be loaded into memory 105 and run by processor 109. Web server 112 provides web pages for the users to interact with in order to be provided with auction functions. For example, web server 112 may serve up web pages to seller system 102 and buyer system 103 in order to allow seller system 102 and/or buyer system 103 to use If-bidding, as well as to view events and auction items to make bids and to participate in auctions. Storage 106 includes information about respective users, such as seller information 114 and buyer information 115. This information is used to support If-bidding, manage the inventory of items for sale, configuration of auction events, and the processing of real-time action functions. According to various embodiments, auction system 100 may include one or a plurality of auction servers 101 in various configurations and architectures to provide auctions and bidding functionality.

Seller system 102 and/or buyer system 103 may comprise computer systems coupled to a network such as Internet 104 according to an embodiment. As shown, seller system 102 includes processor 120 and software components such as browser 123 and communications software 121. Also included is a display 124 that allows a user to access and view If-bidding information as well as information regarding auctions and to perform related administration. Buyer system 103 also includes a processor 130, communication software 131, browser 132, and display 133. Various browser software or other software or functionality to provide user interaction may be used in buyer and seller systems. For example, browsers may include, but are not limited to, Internet Explorer, Netscape browser, Firefox browser, Safari browser or other browser. Alternatively, other user interface software not including a browser may be used.

Software such as web server 112, real-time auction software 113, and dynamic pricing and If-bidding component 150 may be stored in storage 106 or other storage and may be loaded into memory 105 for manipulation by processor 109 according to an embodiment. Portions of data such as seller information 114 and buyer information 115 may be loaded into data structures in memory 105 or other storage for manipulation by processor 109 in accordance with software such as web server 112, real-time auction software 113, and the dynamic pricing and If-bidding component 150. Web server 112 includes an operating system for managing system resources, such as Microsoft Windows XP, 2000, 98, or NT, Apple OS, Linux, or other operating systems as well as applications software running on top of the operating systems for implementing an HTML server or other server. Information stored in storage 106 may be stored in various forms of database arrangements and may contain cross references or links to one another to allow information to be queried and retrieved. In an example embodiment, the information is stored in databases, such as relational databases, and may be queried using structured query language (SQL) or other mechanism.

The system may include a secure connection or connections. For example, in an embodiment, the entire bidding operation of the system operates on a secure connection or connections. Various different technologies may be used to provide a secure connection, such as encryption with, for example, public key and private key encryption. The system may be set up over a virtual private network (VPN).

In an example embodiment, a seller operates seller system 102 through browser 123, communications software 121, and display 124 to set up seller inventory and seller events in seller information storage 114. The seller-user also manages the events and bidding through seller system 102, which communicates via Internet 104 with web server 112. The seller manages and controls the dynamic pricing and If-bidding through seller system 102, which communicates via Internet 104 with the dynamic pricing and If-bidding component 150.

Buyer system 103 interacts with a buyer user, allowing the buyer user to view pricing information as well as items and events including the items for auction. The interaction is provided to the buyer user through display 133, browser 132, and communications software 131, which are controlled by processor 130. Buyer system in turn communicates with auction server 101 via Internet 104. Web server 112 in turn provides buyer system 103 with graphical interface pages which may be displayed on display 133. Components and functions of the electronic auction system 100 are described further in the Related Applications described above.

The dynamic pricing and If-bidding component 150 of the auction system 100 of an embodiment provides and enables the dynamic pricing and If-bidding during auctions, as described above. The dynamic pricing allows pricing to be adjusted dynamically but allows sellers (consignors) to retain control of the equipment on which the price is adjusted, the amount of the pricing adjustment, and the timing of the adjustment. Starting bidding at the floor price leads to premium pricing since vehicles depreciate and most vehicles are priced based on historical information. However, the If-bidding bid review management process can be used for bids at or above start prices but below reserve (which remains at “market average” price) in order to engage sellers and buyers and increase the probability of achieving market prices because sellers always have the option of rejecting an If-bid. The If-bidding provides for additional pricing flexibility online, much like physical auctions, where the seller has more control over the auction process. The If-bid functionality therefore is a process that provides visibility of today's market conditions and facilitates liquidity in the marketplace for the sellers and buyers (dealers) to get engaged.

Dynamic pricing, as used herein, refers to the adjusting of vehicle prices over the auction lifecycle of a subject vehicle. The adjustments to auction prices enabled by dynamic pricing include adjustments to the open price, or adjustments to the open price and the reserve price. The adjustments generally include fixed amounts (by model or across the board), and are based on unique buyer interest. Furthermore, a vehicle is identified as a candidate for If-bidding when the highest bid received on the vehicle during an auction iteration is below the reserve price. The If-bidding process and components described herein enable the seller to revisit their reserve, and as necessary, entice a buyer to place a bid and get engaged in the auction.

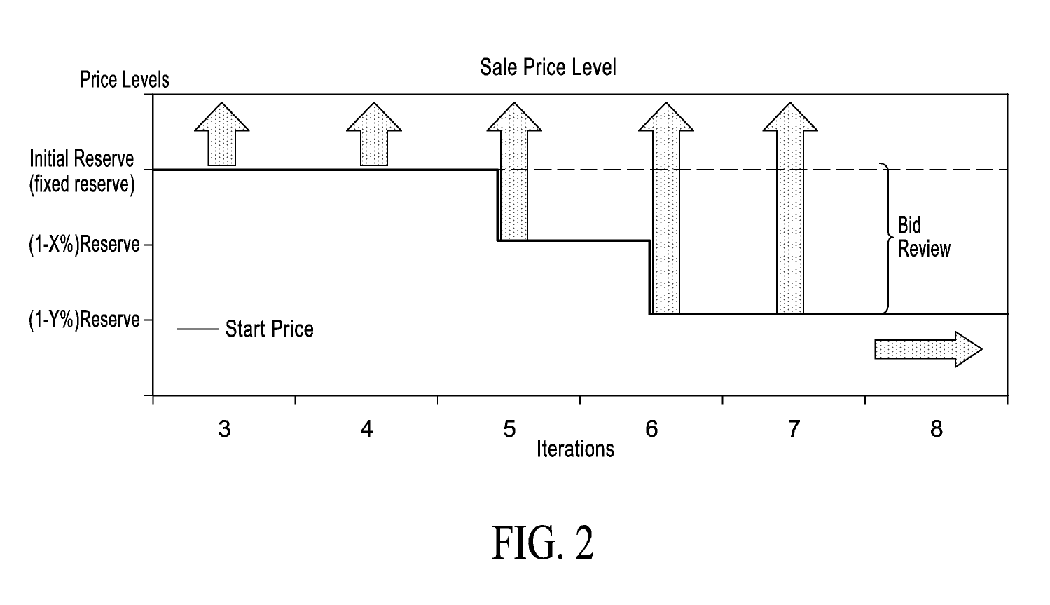

FIG. 2 shows six iterations (iterations 3, 4, 5, 6, 7, and 8) of an example vehicle auction lifecycle using dynamic pricing, under an embodiment. For early bidding iterations (e.g., through the fourth iteration), the auction is started with the open price or start price equal to the reserve price, which maximizes the probability of selling vehicles no lower than the forecasted market price. For subsequent iterations (e.g., iterations 5, 6, 7, 8, etc.) in an embodiment, the opening price is lowered but the reserve price remains fixed, which attracts bidder attention to a vehicle. The seller subsequently reviews each vehicle with a bid under the reserve to evaluate and reserve.

Dynamic pricing and If-bidding should be introduced to the auction cycle of a vehicle after the vehicle has had as much visibility as possible in the online auction channel. Dynamic pricing and If-bidding can be used at any one or more iterations of the vehicle auction lifecycle. In the example shown, Dynamic pricing is used in the fifth and subsequent auction iterations, but the embodiment is not so limited. The amount of price lowering during any iteration can be any amount as determined by the seller. For example, when using dynamic pricing in this example auction lifecycle, the open or start price in a fifth auction iteration is X percent below the initial reserve price ((1−X%)*Reserve), and the open price in the sixth and subsequent auction iterations is Y percent below reserve price ((1−Y%)*Reserve), where each of X and Y independently represent any value greater than zero (0) and less than one (1). As one specific example, the open price in the fifth auction iteration can be three (3) percent (X equals 0.03) below reserve price, while the open price in a second If-bid iteration can be five (5) percent (Y equals 0.05) below reserve price.

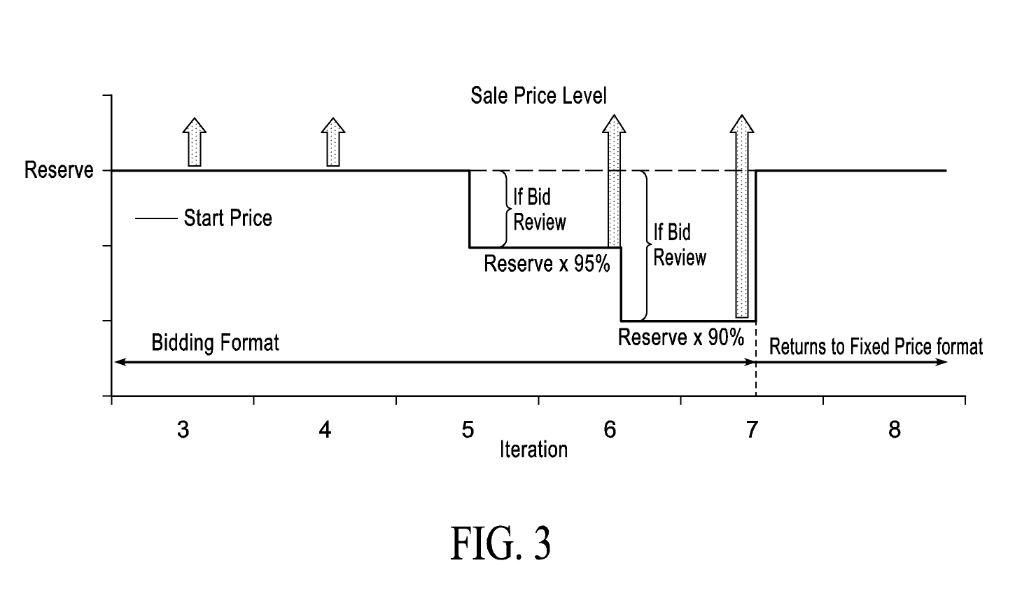

FIG. 3 shows six iterations (iterations 3, 4, 5, 6, 7, and 8) of another example vehicle auction lifecycle using dynamic pricing, under an embodiment. For the first four (4) bidding iterations, the open price is set to equal the reserve price. The opening price is lowered in the fifth and sixth iterations, but the reserve price remains fixed, which attracts bidder attention to a vehicle. In the example shown, dynamic pricing is used in the fifth and sixth iterations, but the embodiment is not so limited. The amount of price lowering during any iteration can be any amount as determined by the seller. For example, dynamic pricing is used in this example auction lifecycle to adjust the open or start price in the fifth auction iteration to an amount five (5) percent below the initial reserve price or start price. Similarly, dynamic pricing is used in this example auction lifecycle to adjust the open or start price in the sixth auction iteration to an amount ten (10) percent below the initial reserve price or start price. The open price returns to the initial reserve price for the seventh and subsequent iterations.

Dynamic pricing and If-bidding provides sellers with visibility into current market conditions, and helps sellers with pricing decisions by getting ‘closer’ to the market value while retaining complete control of the price for which sellers are willing to complete a sale at or below a forecasted market price. As described above, dynamic pricing enables a seller to position open prices lower than floor prices during auction iterations. Further, floor prices should remain at the seller's full reserve, as positioned in earlier iterations of the vehicle lifecycle, as long as the seller is making reasonable bid review decisions during the auction adjudication window. Open prices should be set based on vehicle interest, where interest in an embodiment is determined by the number of times that vehicle detail page has been viewed and/or unique dealers viewing that vehicle on the online auction system. The vehicle seller can consider any number and/or type of parameters of the vehicle when determining whether to implement dynamic pricing and/or when determining a reserve price for an auction iteration using dynamic pricing. When reviewing bids in consideration of the use of dynamic pricing and If-bidding, for example, the seller should consider one or more of the condition of the subject vehicle, the number of dealer views on the vehicle (seller should be relatively aggressive on vehicles with a large number of views), and current market price to name a few. With the right price achieved through the dynamic pricing and If-bidding comes increased dealer activity, higher conversion or sales rates, and ultimately maximized portfolio results. Consequently, dynamic pricing and If-bidding provides buyers with a forum for engagement, thereby encouraging buyer (dealer) participation. Further, the dynamic pricing and If-bidding results in more views per vehicle, increased bidding activity, and more dealers buying vehicles, thereby increasing the probability of sellers selling, and buyers buying the ‘right’ car at the ‘right’, true market price.

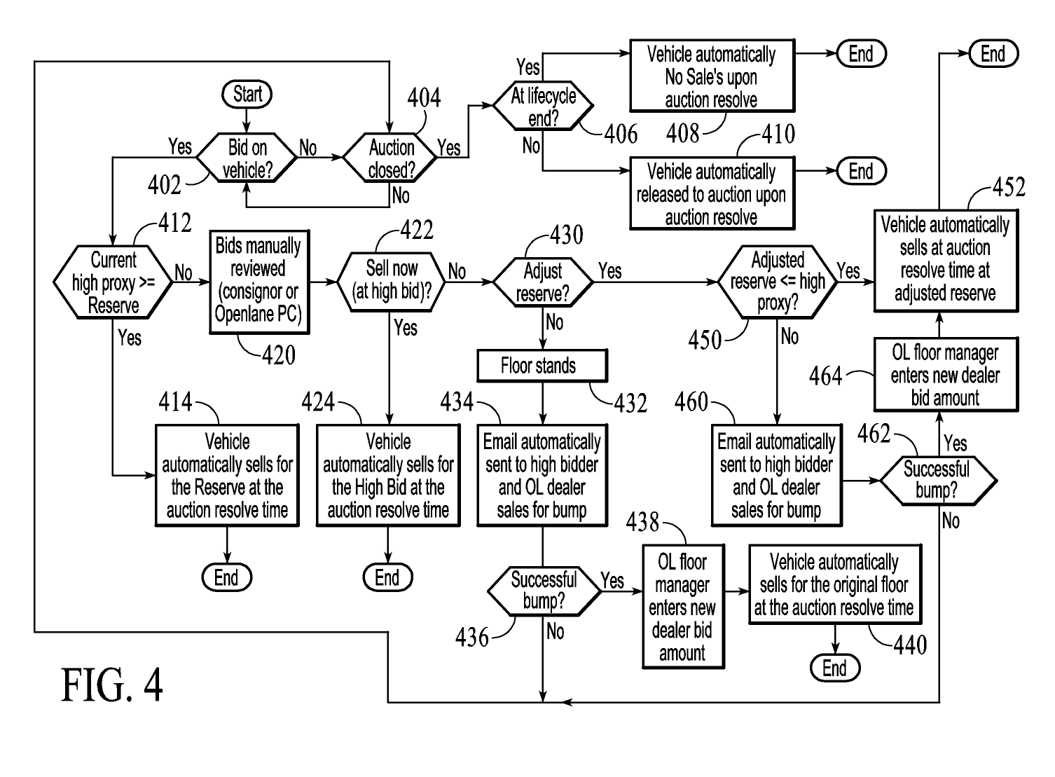

FIG. 4 is a flow diagram of If-bidding auction adjudication, under an embodiment. The system determines if a bid is received on a vehicle 402. When no bid is received, a determination is made as to whether the auction is closed or ended 404. The decision whether the auction is closed can be performed automatically using rules running or hosted on the auction system, or can be conducted manually. If the auction is not closed then another determination is made as to whether a bid is received on the vehicle 402 (operation loops until bid received or auction closes).

If the auction is closed, a determination is made whether the vehicle is at the end of the vehicle auction lifecycle 406. The decision whether the vehicle is at the end of the auction lifecycle can be performed automatically using rules running or hosted on the auction system, or can be conducted manually. If the vehicle is at the end of the auction lifecycle, then the status of the vehicle is automatically updated to reflect no sale at the auction resolve time 408. If the vehicle is not at the end of the auction lifecycle, then the vehicle is automatically released to the auction for another auction iteration at the auction resolve time 410.

When a bid is received (either before the end of the auction or after the auction ends), a determination is made whether the high bidder's proxy bid is greater than or equal to the reserve price 412. If the current high proxy is greater than or equal to the reserve price and the auction has ended, then the vehicle corresponding to the bid automatically sells for the highest price above the reserve price and any competing bids at the auction resolve time. Subsequent bids may be placed on that vehicle up until the auction close time.

In an embodiment, whether the vehicle corresponding to the bid automatically sells for the highest price above the reserve price and any competing bids at the auction resolve time when the current high proxy is greater than or equal to the reserve price depends on options selected by the corresponding bidder. The options or option settings, also referred to herein as bidder bid placement and adjudication options, include multiple options for the scenario when a bid is placed, and numerous options under the scenario when the seller adjusts the reserve and the reserve has not already been met, as described in detail below.

When a bidder places a bid, under a first option, the bidder is immediately taken to reserve and the bidder's current bid is set equal to the reserve if the bidder's proxy bid is greater than or equal to reserve. If the bidder's proxy bid is less than reserve, the bidder's current bid is set upward to the next bid increment.

A second option when a bidder places a bid is, instead of taking the bidder to reserve and setting the current bid equal to reserve as under the first option, to set the bidder's current bid upward to the next bid increment. Under this option, the bidder's proxy bid is only used to counter another bidder.

For the scenario in which a seller adjusts the reserve when the reserve has not already been met, as described in detail below, a first option for a bidder allows the bidder to move on and, if necessary, to reduce their proxy bid to an increment below the adjusted reserve. Under this option, the online auction system contacts the bidder with the seller's final price if the bidder is the high bidder at the end of the auction and, as such, the bidder does not win the corresponding vehicle at auction without taking further action subsequent to contact by the online auction system.

A second option for the bidder, when a seller adjusts the reserve and the reserve has not already been met, requires competitive bidding. Consequently, under this second option, the auction system retains the proxy bid of the bidder. If the bidder is the high bidder at the end of the auction and the bidder's current bid achieved through competitive bidding is greater than or equal to the seller's final price, the bidder agrees to buy the car at the seller's final price.

Under a third option, when a seller adjusts the reserve and the reserve has not already been met, the bidder wants the vehicle, the auction system retains the proxy bid of the bidder. If the bidder is the high bidder at the end of the auction and the bidder's proxy bid is greater than or equal to the seller's final price, the bidder agrees to buy the car at the seller's final price.

Continuing with If-bidding auction adjudication process, if the current high proxy is not greater than or equal to the reserve price, then the bid may be reviewed 420 prior to or after the auction end, and a determination is made as to whether to sell the vehicle now (end the auction early) for the current high bid 422. The review of the bid, and consequently the decision whether to sell the vehicle immediately, can be conducted manually by an auction employee or by the seller, or can be performed automatically using rules established or selected by the seller and running or hosted on the auction system.

If the decision is made to sell the vehicle now for the current high bid, the vehicle corresponding to the bid automatically sells for the amount of the high bid at the auction resolve time 424 but no other bids can be placed. If the decision made is not to sell the vehicle immediately for the current high bid, then a determination is made whether to adjust the reserve price 430.

When the seller decides not to sell the vehicle immediately for the current high bid, and the determination is made not to adjust the reserve price, then the floor price stands 432, and an electronic notification is automatically sent to the high bidder in an effort to entice the high bidder to increase their bid 434. Such electronic notification may be done by email (as in this example), by text message, by online chat, or even a non-electronic method such as a telephone call or other embodiment. Subsequent to transmission of the electronic notification to the high bidder a determination is made whether the high bidder has increased or bumped their bid 436. When the bidder increases their bid in response to the electronic notification, then the new bid amount is entered 438, and the vehicle corresponding to the bid automatically sells for the original floor price at the auction resolve time 440.

When the bidder does not increase their bid in response to the electronic notification, then a determination is made as to whether the auction is closed 404. The decision whether the auction is closed can be performed automatically using rules running or hosted on the auction system, or can be conducted manually. If the auction is not closed then a determination is made as to whether another bid is received on the vehicle 402.

If the auction is closed, a determination is made whether the vehicle is at the end of the auction lifecycle 406. The decision whether the vehicle is at the end of the auction lifecycle can be performed automatically using rules running or hosted on the auction system, or can be conducted manually. If the vehicle is at the end of the auction lifecycle, then the status of the vehicle is automatically updated to reflect no sale at the auction resolve time 408. If the vehicle is not at the end of the auction lifecycle, then the vehicle is automatically released to the auction at the auction resolve time 410 for another auction iteration.

When the decision is made not to sell the vehicle for the current high bid 422, but a determination is that the current reserve is too high, the reserve price is adjusted down 430 (reserve prices can never be increased once a vehicle has a bid placed). A determination is then made whether the adjusted reserve price is less than or equal to the high bid (proxy) 450, where the determination can be performed automatically using rules running or hosted on the auction system, or can be conducted manually. When the adjusted reserve price is determined to be less than or equal to the high proxy, then the vehicle corresponding to the bid automatically sells for the adjusted reserve price at the auction resolve time 452 at the highest bid that meets or exceeds the reserve price.

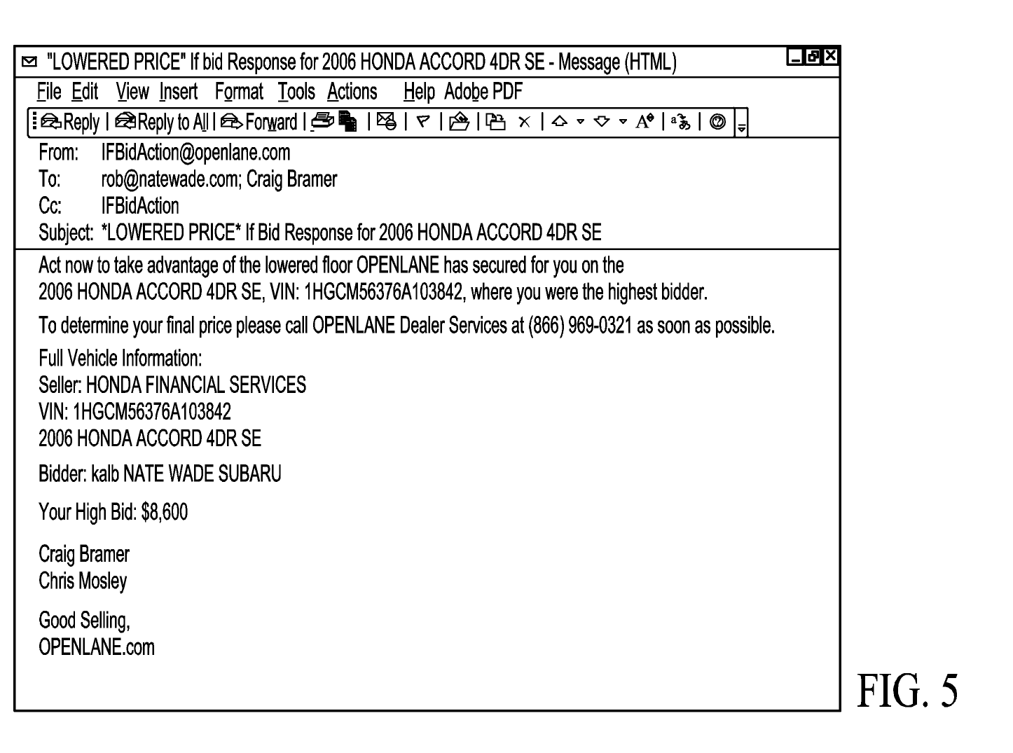

When the adjusted reserve price is determined to be greater than the high proxy, an electronic communication (e.g., electronic mail, telephone call, text message, online chat, etc.) is automatically sent to the high bidder informing the high bidder of the lowered reserve price in an effort to entice the high bidder into increasing their bid 460. FIG. 5 is an example electronic mail sent to the high bidder by the If-bidding component, under an embodiment. Subsequent to transmission of the electronic communication to the high bidder a determination is made whether the high bidder has increased or bumped their bid 462. If the bidder increases their bid to the new floor in response to the electronic communication, then the new bid is entered 464, and the vehicle corresponding to the bid automatically sells for the adjusted floor price at the auction resolve time 452. When the bidder does not increase their bid in response to the electronic mail, then a determination is made as to whether the auction is closed 404. The decision whether the auction is closed can be performed automatically using rules running or hosted on the auction system, or can be conducted manually.

If the auction is not closed then a determination is made as to whether another bid is received on the vehicle 402. If the auction is closed, a determination is made whether the vehicle is at the end of the auction lifecycle 406. The decision whether the vehicle is at the end of the auction lifecycle can be performed automatically using rules running or hosted on the auction system, or can be conducted manually. If the vehicle is at the end of the auction lifecycle, then the status of the vehicle is automatically updated to reflect no sale at the auction resolve time 408. If the vehicle is not at the end of the auction lifecycle, then the vehicle is automatically released to the auction at the auction resolve time 410.

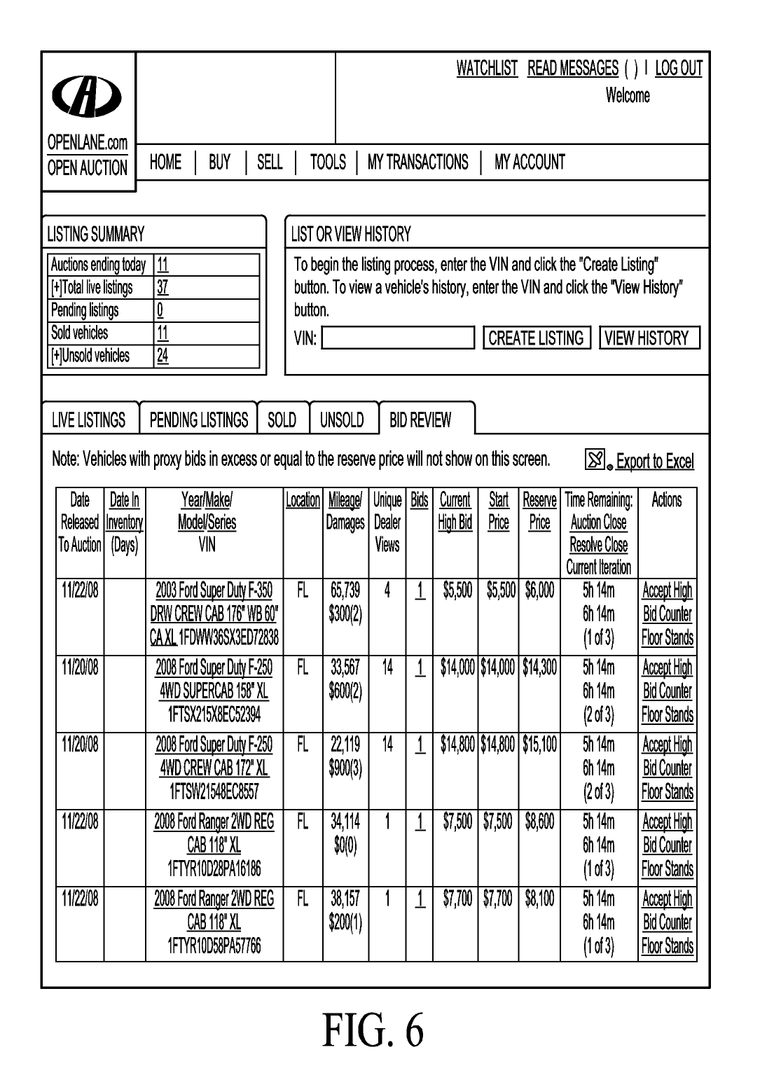

The If-bidding component of an embodiment comprises a “BID REVIEW” interface that is presented to the seller via the seller system (FIG. 1, element 102). FIG. 6 is an example BID REVIEW interface of the If-bidding, under an embodiment. The BID REVIEW interface of this example comprises one tab of an electronic interface that includes one or more additional tabs representing information of vehicle auctions. The BID REVIEW interface includes the following information for each of seller's vehicles at auction, but is not limited to presenting only this information: date vehicle released to auction; date in inventory (days); vehicle year; vehicle make; vehicle model; vehicle series; vehicle identification number (VIN); location of vehicle; mileage; estimate of any vehicle damage; number of unique dealer views corresponding to the vehicle; number of bids received; current high bid; start price; reserve price; time remaining to auction close; time remaining to auction resolve close; time remaining in current auction iteration; actions that can be selected by dealer (e.g., accept high bid; counter; floor stands; etc.). The BID REVIEW interface of this example is presented along with other seller information comprising, for example, a listing summary of seller's vehicles, and an interface that enables the seller to create a listing and/or view a history of vehicles at auction.

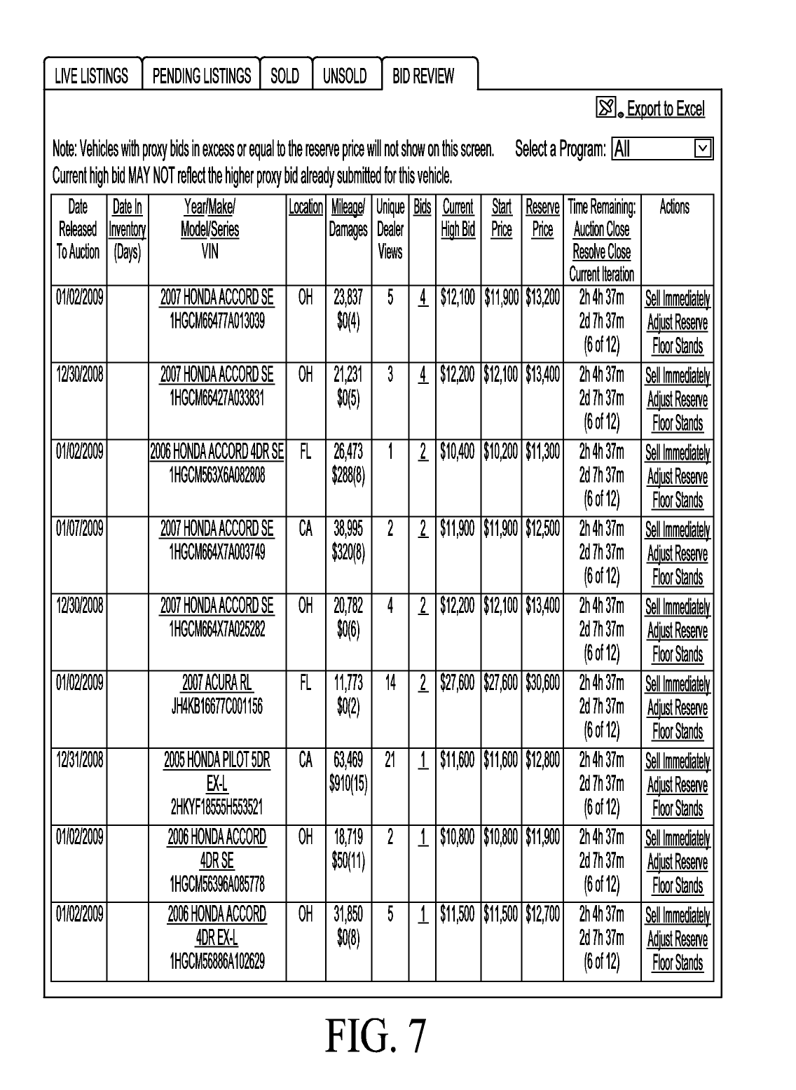

The BID REVIEW interface of an alternative embodiment can be presented in a dedicated window or interface page without the presentation of other seller information. FIG. 7 is an example BID REVIEW interface of the If-bidding, under an alternative embodiment. The BID REVIEW interface of this example comprises one tab of an electronic interface that includes one or more additional tabs representing information of vehicle auctions. The BID REVIEW interface includes the following information for each of seller's vehicles at auction, but is not limited to presenting only this information: date vehicle released to auction; date in inventory (days); vehicle year; vehicle make; vehicle model; vehicle series; vehicle identification number (VIN); location of vehicle; mileage; estimate of any vehicle damage; number of unique dealer views corresponding to the vehicle; number of bids received; current high bid; start price; reserve price; time remaining to auction close; time remaining to auction resolve close; time remaining in current auction iteration; actions that can be selected by dealer (e.g., accept high bid; counter; floor stands; etc.).

Various functions of the If-bidding component and process described above can be performed manually or automatically, as understood by one skilled in the art. A description follows of example functions of the If-bidding that can be performed automatically by the If-bidding component working autonomously or in cooperation with one or more other components of the of the auction system 100 (FIG. 1).

The dynamic pricing and If-bidding component of an embodiment automatically determines a new floor amount to be used during auction iterations for which the seller has decided to use dynamic pricing and If-bidding. The dynamic pricing and If-bidding component of an embodiment automatically notifies sellers of vehicles qualifying for If-bidding prior to auction close and during the “resolve window” (e.g., tickler messages; more information available on demand for users of smart phones to actually process vehicles).

The dynamic pricing and If-bidding component of an embodiment performs automated notification and acceptance by a high bidder of the floor price during the “resolve window.” For example, an electronic message in the form of an electronic mail and/or short message service message is sent to a dealer that identifies a subject vehicle (e.g., by VIN) and informs the dealer of the amount of the new floor price. The message includes prompts that allow the recipient to accept or reject the new floor price (e.g., “to accept reply “yes”, and to reject reply “no”). The electronic message can optionally include notification of any time limit associated with the new floor price (e.g., “Your opportunity may be lost 45 minutes after you receive this message).

The dynamic pricing and If-bidding component of an embodiment performs automated notification and acceptance by non-high-bidders of a floor price for a vehicle in the “resolve window”. The non-high-bidders include, for example, clean-up dealers that review vehicles with adjusted reserves that they did not bid on, dealers that were outbid on vehicles on which they placed a bid (these outbid dealers may be interested in the vehicle at the lowered reserve price), and/or dealers that placed vehicles on a watchlist during the auction.

The dynamic pricing and If-bidding component of an embodiment automatically adjusts the floor price during the “resolve window.” The automatic adjusting comprises, for example, determining, uploading, and/or approving a suggested price as the new floor price. The dynamic pricing and If-bidding component uses one or more factors as inputs to determine the new floor price. For example, the dynamic pricing and If-bidding component generates a “suggested price” using some/all of the following factors, but the embodiment is not so limited: vehicle damage; vehicle configuration; benchmark prices; interest in the vehicle; vehicle age; vehicle location.

When using vehicle damage as an input factor for automatically generating a suggested new floor price, the dynamic pricing and If-bidding component can use the following example factors, but the embodiment is not so limited: estimated repair costs; number of damage items noted in the condition report; severity of damage types (e.g., frame damage drops the value more than a scratch; damaged odometer).

When using vehicle configuration as an input factor for automatically generating a suggested new floor price, the dynamic pricing and If-bidding component can use the following example factors, but the embodiment is not so limited: color (e.g., pink vehicles are worth less than the same vehicle that is black); options (e.g., navigation depreciates quickly; leather retains value); desirability of vehicle location (e.g., cars located in California are more desirable than cars located in Maine).

When using benchmark prices as an input factor for automatically generating a suggested new floor price, the dynamic pricing and If-bidding component can use the following example factors, but the embodiment is not so limited: percentage of benchmark price; add consideration of historical percentage of benchmark price.

When using interest in the vehicle as an input factor for automatically generating a suggested new floor price, the dynamic pricing and If-bidding component can use the following example factors, but the embodiment is not so limited: number of dealers viewing the vehicle detail page of the auction system; types of dealers viewing the vehicle detail page of the auction system; history of purchase and bidding activity for a given dealer.

When using vehicle age as an input factor for automatically generating a suggested new floor price, the dynamic pricing and If-bidding component can use the following example factors, but the embodiment is not so limited: length of time seller has been holding the vehicle; length of time the vehicle has been at auction in wholesale channels.

When using vehicle location as an input factor for automatically generating a suggested new floor price, the dynamic pricing and If-bidding component of an embodiment can use, as an example factor, the supply and demand for a particular vehicle configuration in the area or region where the car is for sale (e.g., a convertible vehicle in Maine during the winter is worth less than the same vehicle in Florida; a vehicle with all weather capability in Maine during the winter is worth more than the same vehicle in Texas).

Under the dynamic pricing and If-bidding of an embodiment, sellers can elect to adjust the open price on a vehicle as a marketing angle, i.e. to draw more attention to their vehicles. The auction system indicates to a buyer which vehicles have had their prices adjusted down through a number of mechanisms including, but not limited to, one or more of the following: on the search results page with a Price Drop icon; on the vehicle detail page with a Price Drop icon; via an email to the dealer that a vehicle they have reviewed has had the price adjusted. Furthermore, the auction system enables buyers to search for cars that have had their prices adjusted.

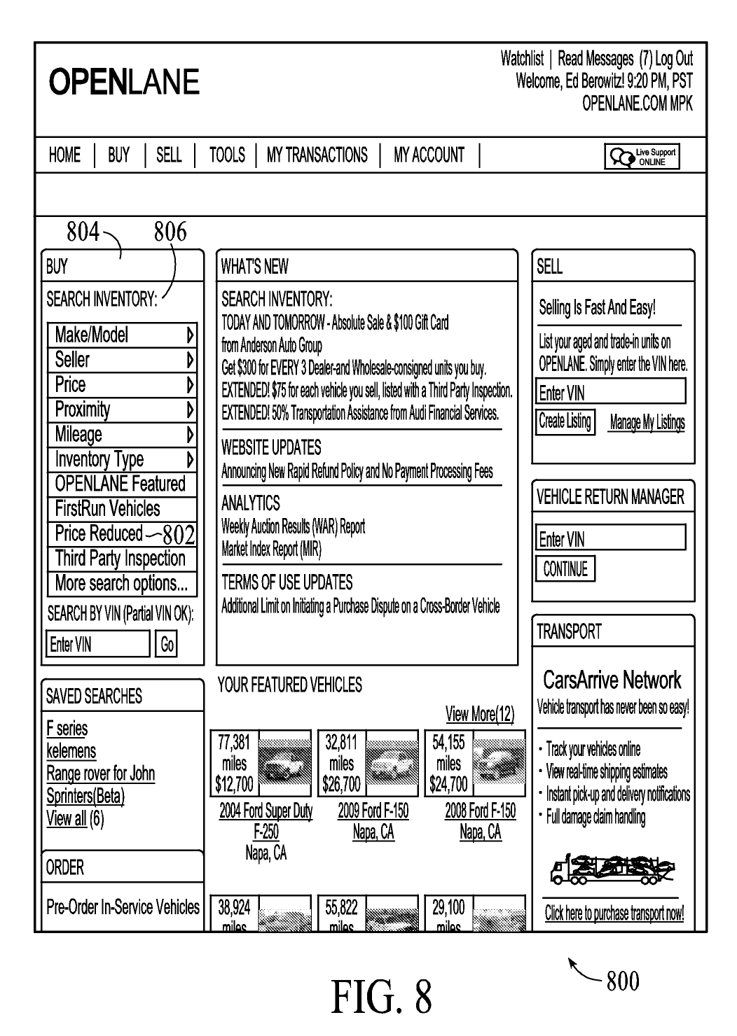

As an example of indications of adjusted prices provided by the auction system, FIG. 8 is an example page 800 that displays indications of which vehicles correspond to adjusted pricing, under an embodiment. This example page provides access to vehicles having adjusted pricing via a “Price Reduced” link 802 in the “BUY” section 804 and “SEARCH INVENTORY” subsection 806 of the page.

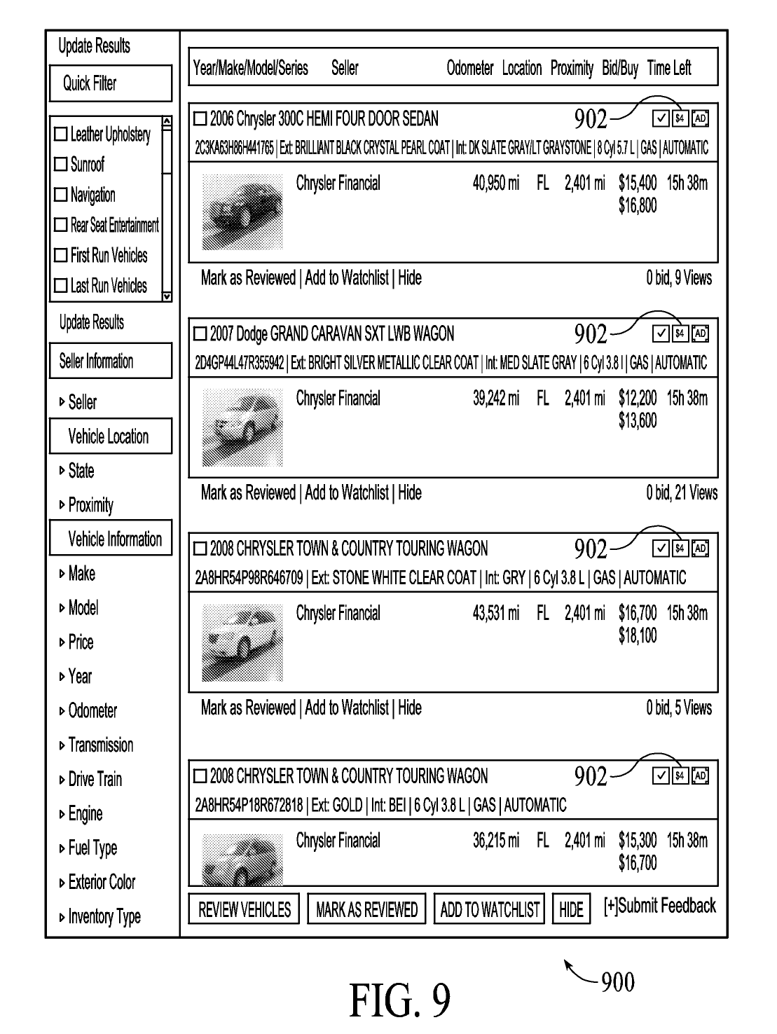

As an alternative example of indications of adjusted prices provided by the auction system, FIG. 9 is an example page 900 that displays indications of which vehicles correspond to adjusted pricing, under an alternative embodiment. This example page provides detail information of numerous vehicles and, along with each vehicle, where appropriate, an icon 902 indicating the vehicle has adjusted pricing.

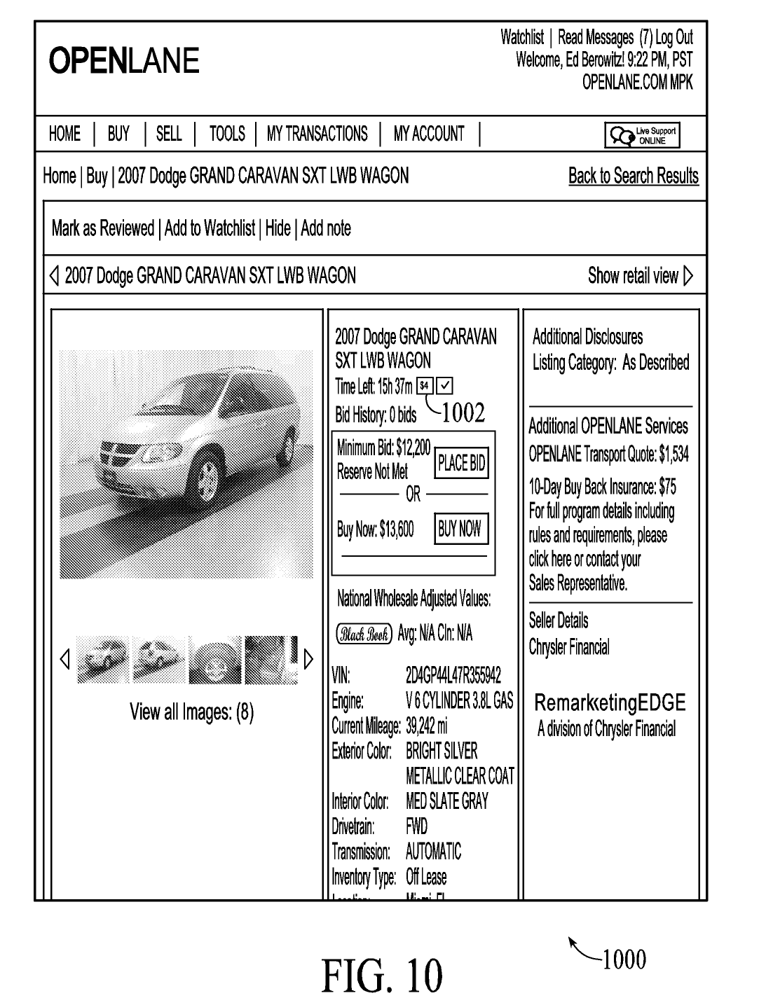

As yet another alternative example of indications of adjusted prices provided by the auction system, FIG. 10 is an example page 1000 that displays indications of which vehicles correspond to adjusted pricing, under an alternative embodiment. This example page provides detail information of a selected vehicle along with an icon 1002 indicating the vehicle has adjusted pricing.

Embodiments described herein include a method running under a processor of an auction system. The method of an embodiment comprises receiving at the auction system a plurality of bids on an item at auction. The auction system is an internet-based auction system. The method of an embodiment comprises automatically evaluating a reserve price of the item and, when determining the reserve price is too high, adjusting the reserve price to an adjusted reserve price when a highest bid of the plurality of bids is less than the reserve price. The method of an embodiment comprises, when the adjusted reserve price is at least one of equal to and less than the highest bid, automatically awarding the item to a high bidder corresponding to the highest bid. The method of an embodiment comprises, when the adjusted reserve price is greater than the highest bid, automatically sending a first electronic message to the high bidder to inform the high bidder that the reserve price has been adjusted and to inform of their status as the high bidder.

Embodiments described herein include a method running under a processor of an auction system, the method comprising: receiving at the auction system a plurality of bids on an item at auction, wherein the auction system is an internet-based auction system; automatically evaluating a reserve price of the item and, when determining the reserve price is too high, adjusting the reserve price to an adjusted reserve price when a highest bid of the plurality of bids is less than the reserve price; when the adjusted reserve price is at least one of equal to and less than the highest bid, automatically awarding the item to a high bidder corresponding to the highest bid; and when the adjusted reserve price is greater than the highest bid, automatically sending a first electronic message to the high bidder to inform the high bidder that the reserve price has been adjusted and to inform of their status as the high bidder.

The method of an embodiment comprises, when the highest bid is at least one of equal to and greater than the reserve price, automatically awarding the item to the high bidder upon termination of the auction.

The method of an embodiment comprises, when the highest bid of the plurality of bids is less than the reserve price, one of automatically terminating the auction and automatically continuing the auction.

The method of an embodiment comprises automatically terminating the auction and awarding the item to the high bidder upon termination of the auction.

The method of an embodiment comprises automatically continuing the auction and maintaining the reserve price.

The method of an embodiment comprises generating a second electronic message to the high bidder to inform the high bidder that the reserve price is being maintained and to inform the high bidder of their status as the high bidder.

The method of an embodiment comprises receiving an increased bid from the high bidder in response to the second electronic message, and automatically awarding the item to the high bidder upon termination of the auction.

The second electronic message of an embodiment includes at least one of electronic mail, Short Message Service message, instant message, and automated telephone call.

The method of an embodiment comprises, in the absence of a response to the second electronic message from the high bidder, determining whether the auction is closed.

The method of an embodiment comprises, in the absence of a response to the second electronic message from the high bidder, determining whether the item is at an end of an auction lifecycle corresponding to the item.

The adjusted reserve price of an embodiment is less than the reserve price.

The method of an embodiment comprises, when the adjusted reserve price is at least one of equal to and less than the highest bid, automatically awarding the item to a high bidder corresponding to the highest bid upon termination of the auction.

The method of an embodiment comprises receiving an increased bid from the high bidder in response to the first electronic message, and when the increased bid is one of equal to and greater than the adjusted reserve price, automatically awarding the item to the high bidder upon termination of the auction.

The second electronic message of an embodiment includes at least one of electronic mail, Short Message Service message, instant message, and automated telephone call.

The method of an embodiment comprises, in the absence of a response to the first electronic message from the high bidder, determining whether the auction is closed.

The method of an embodiment comprises, in the absence of a response to the first electronic message from the high bidder, determining whether the item is at an end of an auction lifecycle corresponding to the item.

The determining the reserve price is too high of an embodiment comprises evaluating at least one of a number of times the item has been viewed by at least one buyer, a condition of the item, and a market price of the item.

The method of an embodiment comprises automatically notifying a seller corresponding to an item when the item qualifies for the adjusting of the reserve price.

The method of an embodiment comprises automatically generating the adjusted reserve price using data of at least one of item condition, item configuration, item damage, benchmark prices, interest in the item, item age, and item location.

The method of an embodiment comprises presenting a bid review interface to a seller of the item, wherein the bid review interface includes access to a plurality of bid review data that includes at least one of data item in inventory, date item released to auction, estimate of damage, a number of times that item data corresponding to the item has been viewed by at least one buyer, a number of different buyers that have viewed the item, a number of bids received on the item, current high bid, open price, reserve price, time remaining to auction close, time remaining to auction resolve, and time remaining in auction iteration.

The bid review interface of an embodiment comprises an interface for initiating a plurality of actions taken by a bidder during the auction.

Embodiments described herein include a system comprising an auction system including a processor and a database coupled to a network and hosting an auction on the network. The system of an embodiment includes an adjudication application running on the auction system. The adjudication application receives a plurality of bids on an item during the auction and automatically evaluates a reserve price of the item and, when determining the reserve price is too high, adjusts the reserve price to an adjusted reserve price when a highest bid of the plurality of bids is less than the reserve price. The system of an embodiment, when the adjusted reserve price is at least one of equal to and less than the highest bid the adjudication application, automatically awards the item to a high bidder corresponding to the highest bid. The system of an embodiment, when the adjusted reserve price is greater than the highest bid the adjudication application, automatically sends an electronic message to the high bidder to inform the high bidder that the reserve price has been adjusted and to inform of their status as the high bidder.

Embodiments described herein include a system comprising: an auction system including a processor and a database coupled to a network and hosting an auction on the network; and an adjudication application running on the auction system, the adjudication application receiving a plurality of bids on an item during the auction and automatically evaluating a reserve price of the item and, when determining the reserve price is too high, adjusting the reserve price to an adjusted reserve price when a highest bid of the plurality of bids is less than the reserve price, wherein when the adjusted reserve price is at least one of equal to and less than the highest bid the adjudication application automatically awards the item to a high bidder corresponding to the highest bid, wherein when the adjusted reserve price is greater than the highest bid the adjudication application automatically sends an electronic message to the high bidder to inform the high bidder that the reserve price has been adjusted and to inform of their status as the high bidder.

The adjudication application of an embodiment, when the highest bid is at least one of equal to and greater than the reserve price, automatically awards the item to the high bidder upon termination of the auction.

The adjudication application of an embodiment, when the highest bid of the plurality of bids is less than the reserve price, one of automatically terminates the auction and automatically continues the auction.

The adjudication application of an embodiment automatically terminates the auction and awards the item to the high bidder upon termination of the auction.

The adjudication application of an embodiment automatically continues the auction and maintains the reserve price.

The adjudication application of an embodiment generates a second electronic message to the high bidder to inform the high bidder that the reserve price is being maintained and to inform the high bidder of their status as the high bidder.

The adjudication application of an embodiment receives an increased bid from the high bidder in response to the second electronic message, and automatically awards the item to the high bidder upon termination of the auction.

The second electronic message of an embodiment includes at least one of electronic mail, Short Message Service message, instant message, and automated telephone call.

The adjudication application of an embodiment, in the absence of a response to the second electronic message from the high bidder, determines whether the auction is closed.

The adjudication application of an embodiment, in the absence of a response to the second electronic message from the high bidder, determines whether the item is at an end of an auction lifecycle corresponding to the item.

The adjusted reserve price of an embodiment is less than the reserve price.

The adjudication application of an embodiment, when the adjusted reserve price is at least one of equal to and less than the highest bid, automatically awards the item to a high bidder corresponding to the highest bid upon termination of the auction.

The adjudication application of an embodiment receives an increased bid from the high bidder in response to the first electronic message, and when the increased bid is one of equal to and greater than the adjusted reserve price, automatically awards the item to the high bidder upon termination of the auction.

The second electronic message of an embodiment includes at least one of electronic mail, Short Message Service message, instant message, and automated telephone call.

The adjudication application of an embodiment, in the absence of a response to the first electronic message from the high bidder, determines whether the auction is closed.

The adjudication application of an embodiment, in the absence of a response to the first electronic message from the high bidder, determines whether the item is at an end of an auction lifecycle corresponding to the item.

The determining the reserve price is too high of an embodiment comprises evaluating at least one of a number of times the item has been viewed by at least one buyer, a condition of the item, and a market price of the item.

The adjudication application of an embodiment automatically notifies a seller corresponding to an item when the item qualifies for the adjusting of the reserve price.

The adjudication application of an embodiment automatically generates the adjusted reserve price using data of at least one of item condition, item configuration, item damage, benchmark prices, interest in the item, item age, and item location.

The adjudication application of an embodiment presents a bid review interface to a seller of the item, wherein the bid review interface includes access to a plurality of bid review data that includes at least one of data item in inventory, date item released to auction, estimate of damage, a number of times that item data corresponding to the item has been viewed by at least one buyer, a number of different buyers that have viewed the item, a number of bids received on the item, current high bid, open price, reserve price, time remaining to auction close, time remaining to auction resolve, and time remaining in auction iteration.

The bid review interface of an embodiment comprises an interface for initiating a plurality of actions taken by a bidder during the auction.

Embodiments described herein include a method running under a processor of an auction system that is an internet-based system, the method comprising, in response to buyer interest factors that correspond to an item begin auctioned during an action hosted by the auction system, dynamically adjusting an opening price of the item to be less than a reserve price of the item during at least one iteration of the auction. The method of an embodiment receives at the auction system a plurality of bids on the item and, when the plurality of bids on the item is greater than the opening price and lower than the reserve price of the item, automatically determines the reserve price is too high and adjusts the reserve price to an adjusted reserve price when a highest bid of the plurality of bids is less than the reserve price. The method of an embodiment, when the adjusted reserve price is at least one of equal to and less than the highest bid, automatically awards the item to a high bidder corresponding to the highest bid. The method of an embodiment, when the adjusted reserve price is greater than the highest bid, automatically sends an electronic message to the high bidder to inform the high bidder that the reserve price has been adjusted and to inform of their status as the high bidder.

Embodiments described herein include a method running under a processor of an auction system that is an internet-based system, the method comprising: in response to buyer interest factors that correspond to an item begin auctioned during an action hosted by the auction system, dynamically adjusting an opening price of the item to be less than a reserve price of the item during at least one iteration of the auction; and receiving at the auction system a plurality of bids on the item and, when the plurality of bids on the item is greater than the opening price and lower than the reserve price of the item, automatically determining the reserve price is too high and adjusting the reserve price to an adjusted reserve price when a highest bid of the plurality of bids is less than the reserve price; when the adjusted reserve price is at least one of equal to and less than the highest bid, automatically awarding the item to a high bidder corresponding to the highest bid; when the adjusted reserve price is greater than the highest bid, automatically sending an electronic message to the high bidder to inform the high bidder that the reserve price has been adjusted and to inform of their status as the high bidder.

The buyer interest factors of an embodiment comprise a number of times that item data corresponding to the item has been viewed by at least one buyer.

The buyer interest factors of an embodiment comprise a number of different buyers that have viewed the item.

The dynamically adjusting the opening price of an embodiment comprises a seller of the item controlling at least one of the item, an amount of the adjusting, and timing of the adjusting.

The method of an embodiment comprises determining the opening price using at least one of a number of times the item has been viewed by at least one buyer and a number of different buyers that have viewed the item.

The method of an embodiment comprises, when the highest bid is at least one of equal to and greater than the reserve price, automatically awarding the item to the high bidder upon termination of the auction.

The method of an embodiment comprises, when the highest bid of the plurality of bids is less than the reserve price, one of automatically terminating the auction and automatically continuing the auction.

The method of an embodiment comprises automatically terminating the auction and awarding the item to the high bidder upon termination of the auction.

The method of an embodiment comprises automatically continuing the auction and maintaining the reserve price.

The method of an embodiment comprises generating a second electronic message to the high bidder to inform the high bidder that the reserve price is being maintained and to inform the high bidder of their status as the high bidder.

The method of an embodiment comprises receiving an increased bid from the high bidder in response to the second electronic message, and automatically awarding the item to the high bidder upon termination of the auction.

The second electronic message of an embodiment includes at least one of electronic mail, Short Message Service message, instant message, and automated telephone call.

The method of an embodiment comprises, in the absence of a response to the second electronic message from the high bidder, determining whether the auction is closed.

The method of an embodiment comprises, in the absence of a response to the second electronic message from the high bidder, determining whether the item is at an end of an auction lifecycle corresponding to the item.

The adjusted reserve price of an embodiment is less than the reserve price.

The method of an embodiment comprises, when the adjusted reserve price is at least one of equal to and less than the highest bid, automatically awarding the item to a high bidder corresponding to the highest bid upon termination of the auction.

The method of an embodiment comprises receiving an increased bid from the high bidder in response to the first electronic message, and when the increased bid is one of equal to and greater than the adjusted reserve price, automatically awarding the item to the high bidder upon termination of the auction.

The second electronic message of an embodiment includes at least one of electronic mail, Short Message Service message, instant message, and automated telephone call.

The method of an embodiment comprises, in the absence of a response to the first electronic message from the high bidder, determining whether the auction is closed.

The method of an embodiment comprises, in the absence of a response to the first electronic message from the high bidder, determining whether the item is at an end of an auction lifecycle corresponding to the item.

The determining the reserve price is too high of an embodiment comprises evaluating at least one of a number of times the item has been viewed by at least one buyer, a condition of the item, and a market price of the item.

Embodiments described herein include a system comprising an auction system including a processor and a database coupled to a network and hosting an auction on the network. The system of an embodiment includes a pricing application running on the auction system and dynamically adjusting an opening price of the item to be less than a reserve price of the item during at least one iteration of the auction in response to buyer interest factors that correspond to the item. The system of an embodiment includes an adjudication application running on the auction system and automatically determining a reserve price of the item is too high and adjusting the reserve price to an adjusted reserve price when a highest bid of a plurality of bids is less than the reserve price. The system of an embodiment, when the adjusted reserve price is at least one of equal to and less than the highest bid the adjudication application, automatically awards the item to a high bidder corresponding to the highest bid. The system of an embodiment, when the adjusted reserve price is greater than the highest bid the adjudication application, automatically sends an electronic message to the high bidder to inform the high bidder that the reserve price has been adjusted and to inform of their status as the high bidder.

Embodiments described herein include a system comprising: an auction system including a processor and a database coupled to a network and hosting an auction on the network; a pricing application running on the auction system and dynamically adjusting an opening price of the item to be less than a reserve price of the item during at least one iteration of the auction in response to buyer interest factors that correspond to the item; and an adjudication application running on the auction system and automatically determining a reserve price of the item is too high and adjusting the reserve price to an adjusted reserve price when a highest bid of a plurality of bids is less than the reserve price, wherein when the adjusted reserve price is at least one of equal to and less than the highest bid the adjudication application automatically awards the item to a high bidder corresponding to the highest bid, wherein when the adjusted reserve price is greater than the highest bid the adjudication application automatically sends an electronic message to the high bidder to inform the high bidder that the reserve price has been adjusted and to inform of their status as the high bidder.

The buyer interest factors of an embodiment comprise a number of times that item data corresponding to the item has been viewed by at least one buyer.

The buyer interest factors of an embodiment comprise a number of different buyers that have viewed the item.

The dynamically adjusting the opening price of an embodiment comprises a seller of the item controlling at least one of the item, an amount of the adjusting, and timing of the adjusting.

The system of an embodiment comprises determining the opening price using at least one of a number of times the item has been viewed by at least one buyer and a number of different buyers that have viewed the item.

The adjudication application of an embodiment, when the highest bid is at least one of equal to and greater than the reserve price, automatically awards the item to the high bidder upon termination of the auction.

The adjudication application of an embodiment, when the highest bid of the plurality of bids is less than the reserve price, one of automatically terminates the auction and automatically continues the auction.

The adjudication application of an embodiment automatically terminates the auction and awards the item to the high bidder upon termination of the auction.

The adjudication application of an embodiment automatically continues the auction and maintains the reserve price.

The adjudication application of an embodiment generates a second electronic message to the high bidder to inform the high bidder that the reserve price is being maintained and to inform the high bidder of their status as the high bidder.

The adjudication application of an embodiment receives an increased bid from the high bidder in response to the second electronic message, and automatically awards the item to the high bidder upon termination of the auction.

The second electronic message of an embodiment includes at least one of electronic mail, Short Message Service message, instant message, and automated telephone call.

The adjudication application of an embodiment, in the absence of a response to the second electronic message from the high bidder, determines whether the auction is closed.

The adjudication application of an embodiment, in the absence of a response to the second electronic message from the high bidder, determines whether the item is at an end of an auction lifecycle corresponding to the item.

The adjusted reserve price of an embodiment is less than the reserve price.

The adjudication application of an embodiment, when the adjusted reserve price is at least one of equal to and less than the highest bid, automatically awards the item to a high bidder corresponding to the highest bid upon termination of the auction.

The adjudication application of an embodiment receives an increased bid from the high bidder in response to the first electronic message, and when the increased bid is one of equal to and greater than the adjusted reserve price, automatically awards the item to the high bidder upon termination of the auction.

The second electronic message of an embodiment includes at least one of electronic mail, Short Message Service message, instant message, and automated telephone call.

The adjudication application of an embodiment, in the absence of a response to the first electronic message from the high bidder, determines whether the auction is closed.

The adjudication application of an embodiment, in the absence of a response to the first electronic message from the high bidder, determines whether the item is at an end of an auction lifecycle corresponding to the item.

The determining the reserve price is too high of an embodiment comprises evaluating at least one of a number of times the item has been viewed by at least one buyer, a condition of the item, and a market price of the item.

The systems and methods described herein include and/or run under and/or in association with a processing system. The processing system includes any collection of processor-based devices or computing devices operating together, or components of processing systems or devices, as is known in the art. For example, the processing system can include one or more of a portable computer, portable communication device operating in a communication network, and/or a network server. The portable computer can be any of a number and/or combination of devices selected from among personal computers, cellular telephones, personal digital assistants, portable computing devices, and portable communication devices, but is not so limited. The processing system can include components within a larger computer system.

The processing system of an embodiment includes at least one processor and at least one memory device or subsystem. The processing system can also include or be coupled to at least one database. The term “processor” as generally used herein refers to any logic processing unit, such as one or more central processing units (CPUs), digital signal processors (DSPs), application-specific integrated circuits (ASIC), etc. The processor and memory can be monolithically integrated onto a single chip, distributed among a number of chips or components of a host system, and/or provided by some combination of algorithms. The methods described herein can be implemented in one or more of software algorithm(s), programs, firmware, hardware, components, circuitry, in any combination.

System components embodying the systems and methods described herein can be located together or in separate locations. Consequently, system components embodying the systems and methods described herein can be components of a single system, multiple systems, and/or geographically separate systems. These components can also be subcomponents or subsystems of a single system, multiple systems, and/or geographically separate systems. These components can be coupled to one or more other components of a host system or a system coupled to the host system.

Communication paths couple the system components and include any medium for communicating or transferring files among the components. The communication paths include wireless connections, wired connections, and hybrid wireless/wired connections. The communication paths also include couplings or connections to networks including local area networks (LANs), metropolitan area networks (MANs), wide area networks (WANs), proprietary networks, interoffice or backend networks, and the Internet. Furthermore, the communication paths include removable fixed mediums like floppy disks, hard disk drives, and CD-ROM disks, as well as flash RAM, Universal Serial Bus (USB) connections, RS-232 connections, telephone lines, buses, and electronic mail messages.

Unless the context clearly requires otherwise, throughout the description, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

The above description of embodiments is not intended to be exhaustive or to limit the systems and methods described to the precise form disclosed. While specific embodiments and examples are described herein for illustrative purposes, various equivalent modifications are possible within the scope of other systems and methods, as those skilled in the relevant art will recognize. The teachings provided herein can be applied to other processing systems and methods, not only for the systems and methods described above.

The elements and acts of the various embodiments described above can be combined to provide further embodiments. These and other changes can be made to the embodiments in light of the above detailed description.

In general, in the following claims, the terms used should not be construed to limit the embodiments described above to the specific embodiments disclosed in the specification and the claims, but should be construed to include all systems and methods that operate under the claims. Accordingly, the embodiments described above are not limited by the disclosure, but instead the scope is to be determined entirely by the claims.

While certain aspects of the embodiments described above are presented below in certain claim forms, the inventor contemplates the various aspects of the embodiments described above in any number of claim forms. Accordingly, the inventor reserves the right to add additional claims after filing the application to pursue such additional claim forms for other aspects of the embodiments described above.

What is claimed is:

1. A method running under a processor of an auction system, the method comprising:
receiving at the auction system a plurality of bids on an item at auction, wherein the auction system is an internet-based auction system;
automatically evaluating a reserve price of the item and, when determining the reserve price is too high, adjusting the reserve price to an adjusted reserve price when a highest bid of the plurality of bids is less than the reserve price;
when the adjusted reserve price is at least one of equal to and less than the highest bid, automatically awarding the item to a high bidder corresponding to the highest bid; and
when the adjusted reserve price is greater than the highest bid, automatically sending a first electronic message to the high bidder to inform the high bidder that the reserve price has been adjusted and to inform of their status as the high bidder.

2. The method of claim 1, comprising, when the highest bid is at least one of equal to and greater than the reserve price, automatically awarding the item to the high bidder upon termination of the auction.

3. The method of claim 1, comprising, when the highest bid of the plurality of bids is less than the reserve price, one of automatically terminating the auction and automatically continuing the auction.

4. The method of claim 3, comprising automatically terminating the auction and awarding the item to the high bidder upon termination of the auction.

5. The method of claim 3, comprising automatically continuing the auction and maintaining the reserve price.

6. The method of claim 5, comprising generating a second electronic message to the high bidder to inform the high bidder that the reserve price is being maintained and to inform the high bidder of their status as the high bidder.

7. The method of claim 6, comprising:
receiving an increased bid from the high bidder in response to the second electronic message; and
automatically awarding the item to the high bidder upon termination of the auction.

8. The method of claim 6, wherein the second electronic message includes at least one of electronic mail, Short Message Service message, instant message, and automated telephone call.

9. The method of claim 6, comprising, in the absence of a response to the second electronic message from the high bidder, determining whether the auction is closed.

10. The method of claim 6, comprising, in the absence of a response to the second electronic message from the high bidder, determining whether the item is at an end of an auction lifecycle corresponding to the item.

11. The method of claim 1, wherein the adjusted reserve price is less than the reserve price.

12. The method of claim 11, comprising, when the adjusted reserve price is at least one of equal to and less than the highest bid, automatically awarding the item to a high bidder corresponding to the highest bid upon termination of the auction.

13. The method of claim 11, comprising:
receiving an increased bid from the high bidder in response to the first electronic message; and
when the increased bid is one of equal to and greater than the adjusted reserve price, automatically awarding the item to the high bidder upon termination of the auction.

14. The method of claim 13, wherein the second electronic message includes at least one of electronic mail, Short Message Service message, instant message, and automated telephone call.

15. The method of claim 13, comprising, in the absence of a response to the first electronic message from the high bidder, determining whether the auction is closed.

16. The method of claim 13, comprising, in the absence of a response to the first electronic message from the high bidder, determining whether the item is at an end of an auction lifecycle corresponding to the item.

17. The method of claim 1, wherein the determining the reserve price is too high comprises evaluating at least one of a number of times the item has been viewed by at least one buyer, a condition of the item, and a market price of the item.

18. The method of claim 1, comprising automatically notifying a seller corresponding to an item when the item qualifies for the adjusting of the reserve price.

19. The method of claim 1, comprising automatically generating the adjusted reserve price using data of at least one of item condition, item configuration, item damage, benchmark prices, interest in the item, item age, and item location.

20. The method of claim 1, comprising presenting a bid review interface to a seller of the item, wherein the bid review interface includes access to a plurality of bid review data that includes at least one of data item in inventory, date item released to auction, estimate of damage, a number of times that item data corresponding to the item has been viewed by at least one buyer, a number of different buyers that have viewed the item, a number of bids received on the item, current high bid, open price, reserve price, time remaining to auction close, time remaining to auction resolve, and time remaining in auction iteration.

21. The method of claim 20, wherein the bid review interface comprises an interface for initiating a plurality of actions taken by a bidder during the auction.

22. A system comprising:
an auction system including a processor and a database coupled to a network and hosting an auction on the network; and
an adjudication application running on the auction system, the adjudication application receiving a plurality of bids on an item during the auction and automatically evaluating a reserve price of the item and, when determining the reserve price is too high, adjusting the reserve price to an adjusted reserve price when a highest bid of the plurality of bids is less than the reserve price, wherein when the adjusted reserve price is at least one of equal to and less than the highest bid the adjudication application automatically awards the item to a high bidder corresponding to the highest bid, wherein when the adjusted reserve price is greater than the highest bid the adjudication application automatically sends an electronic message to the high bidder to inform the high bidder that the reserve price has been adjusted and to inform of their status as the high bidder.

23. The system of claim 22, wherein the adjudication application, when the highest bid is at least one of equal to and greater than the reserve price, automatically awards the item to the high bidder upon termination of the auction.

24. The system of claim 22, wherein the adjudication application, when the highest bid of the plurality of bids is less than the reserve price, one of automatically terminates the auction and automatically continues the auction.

25. The system of claim 24, wherein the adjudication application automatically terminates the auction and awards the item to the high bidder upon termination of the auction.

26. The system of claim 24, wherein the adjudication application automatically continues the auction and maintains the reserve price.

27. The system of claim 26, wherein the adjudication application generates a second electronic message to the high bidder to inform the high bidder that the reserve price is being maintained and to inform the high bidder of their status as the high bidder.

28. The system of claim 27, wherein the adjudication application receives an increased bid from the high bidder in response to the second electronic message, and automatically awards the item to the high bidder upon termination of the auction.

29. The system of claim 27, wherein the second electronic message includes at least one of electronic mail, Short Message Service message, instant message, and automated telephone call.

30. The system of claim 27, wherein the adjudication application, in the absence of a response to the second electronic message from the high bidder, determines whether the auction is closed.

31. The system of claim 27, wherein the adjudication application, in the absence of a response to the second electronic message from the high bidder, determines whether the item is at an end of an auction lifecycle corresponding to the item.

32. The system of claim 22, wherein the adjusted reserve price is less than the reserve price.

33. The system of claim 32, wherein the adjudication application, when the adjusted reserve price is at least one of equal to and less than the highest bid, automatically awards the item to a high bidder corresponding to the highest bid upon termination of the auction.

34. The system of claim 32, wherein the adjudication application receives an increased bid from the high bidder in response to the first electronic message, and when the increased bid is one of equal to and greater than the adjusted reserve price, automatically awards the item to the high bidder upon termination of the auction.

35. The system of claim 34, wherein the second electronic message includes at least one of electronic mail, Short Message Service message, instant message, and automated telephone call.

36. The system of claim 34, wherein the adjudication application, in the absence of a response to the first electronic message from the high bidder, determines whether the auction is closed.

37. The system of claim 34, wherein the adjudication application, in the absence of a response to the first electronic message from the high bidder, determines whether the item is at an end of an auction lifecycle corresponding to the item.

38. The system of claim 22, wherein the determining the reserve price is too high comprises evaluating at least one of a number of times the item has been viewed by at least one buyer, a condition of the item, and a market price of the item.

39. The system of claim 22, wherein the adjudication application automatically notifies a seller corresponding to an item when the item qualifies for the adjusting of the reserve price.

40. The system of claim 22, wherein the adjudication application automatically generates the adjusted reserve price using data of at least one of item condition, item configuration, item damage, benchmark prices, interest in the item, item age, and item location.

41. The system of claim 22, wherein the adjudication application presents a bid review interface to a seller of the item, wherein the bid review interface includes access to a plurality of bid review data that includes at least one of data item in inventory, date item released to auction, estimate of damage, a number of times that item data corresponding to the item has been viewed by at least one buyer, a number of different buyers that have viewed the item, a number of bids received on the item, current high bid, open price, reserve price, time remaining to auction close, time remaining to auction resolve, and time remaining in auction iteration.

42. The system of claim 41, wherein the bid review interface comprises an interface for initiating a plurality of actions taken by a bidder during the auction.

43. A method running under a processor of an auction system that is an internet-based system, the method comprising:
in response to buyer interest factors that correspond to an item begin auctioned during an action hosted by the auction system, dynamically adjusting an opening price of the item to be less than a reserve price of the item during at least one iteration of the auction; and
receiving at the auction system a plurality of bids on the item and, when the plurality of bids on the item is greater than the opening price and lower than the reserve price of the item, automatically determining the reserve price is too high and adjusting the reserve price to an adjusted reserve price when a highest bid of the plurality of bids is less than the reserve price;
when the adjusted reserve price is at least one of equal to and less than the highest bid, automatically awarding the item to a high bidder corresponding to the highest bid;
when the adjusted reserve price is greater than the highest bid, automatically sending an electronic message to the high bidder to inform the high bidder that the reserve price has been adjusted and to inform of their status as the high bidder.

44. The method of claim 43, wherein the buyer interest factors comprise a number of times that item data corresponding to the item has been viewed by at least one buyer.

45. The method of claim 43, wherein the buyer interest factors comprise a number of different buyers that have viewed the item.

46. The method of claim 43, wherein the dynamically adjusting the opening price comprises a seller of the item controlling at least one of the item, an amount of the adjusting, and timing of the adjusting.

47. The method of claim 43, comprising determining the opening price using at least one of a number of times the item has been viewed by at least one buyer and a number of different buyers that have viewed the item.

48. The method of claim 43, comprising, when the highest bid is at least one of equal to and greater than the reserve price, automatically awarding the item to the high bidder upon termination of the auction.

49. The method of claim 43, comprising, when the highest bid of the plurality of bids is less than the reserve price, one of automatically terminating the auction and automatically continuing the auction.

50. The method of claim 49, comprising automatically terminating the auction and awarding the item to the high bidder upon termination of the auction.

51. The method of claim 49, comprising automatically continuing the auction and maintaining the reserve price.

52. The method of claim 51, comprising generating a second electronic message to the high bidder to inform the high bidder that the reserve price is being maintained and to inform the high bidder of their status as the high bidder.

53. The method of claim 52, comprising:
receiving an increased bid from the high bidder in response to the second electronic message; and
automatically awarding the item to the high bidder upon termination of the auction.

54. The method of claim 52, wherein the second electronic message includes at least one of electronic mail, Short Message Service message, instant message, and automated telephone call.

55. The method of claim 52, comprising, in the absence of a response to the second electronic message from the high bidder, determining whether the auction is closed.

56. The method of claim 52, comprising, in the absence of a response to the second electronic message from the high bidder, determining whether the item is at an end of an auction lifecycle corresponding to the item.

57. The method of claim 43, wherein the adjusted reserve price is less than the reserve price.

58. The method of claim 57, comprising, when the adjusted reserve price is at least one of equal to and less than the highest bid, automatically awarding the item to a high bidder corresponding to the highest bid upon termination of the auction.

59. The method of claim 57, comprising:
receiving an increased bid from the high bidder in response to the first electronic message; and
when the increased bid is one of equal to and greater than the adjusted reserve price, automatically awarding the item to the high bidder upon termination of the auction.

60. The method of claim 59, wherein the second electronic message includes at least one of electronic mail, Short Message Service message, instant message, and automated telephone call.

61. The method of claim 59, comprising, in the absence of a response to the first electronic message from the high bidder, determining whether the auction is closed.

62. The method of claim 59, comprising, in the absence of a response to the first electronic message from the high bidder, determining whether the item is at an end of an auction lifecycle corresponding to the item.

63. The method of claim 43, wherein the determining the reserve price is too high comprises evaluating at least one of a number of times the item has been viewed by at least one buyer, a condition of the item, and a market price of the item.

64. A system comprising:
an auction system including a processor and a database coupled to a network and hosting an auction on the network;
a pricing application running on the auction system and dynamically adjusting an opening price of the item to be less than a reserve price of the item during at least one iteration of the auction in response to buyer interest factors that correspond to the item; and
an adjudication application running on the auction system and automatically determining a reserve price of the item is too high and adjusting the reserve price to an adjusted reserve price when a highest bid of a plurality of bids is less than the reserve price, wherein when the adjusted reserve price is at least one of equal to and less than the highest bid the adjudication application automatically awards the item to a high bidder corresponding to the highest bid, wherein when the adjusted reserve price is greater than the highest bid the adjudication application automatically sends an electronic message to the high bidder to inform the high bidder that the reserve price has been adjusted and to inform of their status as the high bidder.

65. The system of claim 64, wherein the buyer interest factors comprise a number of times that item data corresponding to the item has been viewed by at least one buyer.

66. The system of claim 64, wherein the buyer interest factors comprise a number of different buyers that have viewed the item.

67. The system of claim 64, wherein the dynamically adjusting the opening price comprises a seller of the item controlling at least one of the item, an amount of the adjusting, and timing of the adjusting.

68. The system of claim 64, comprising determining the opening price using at least one of a number of times the item has been viewed by at least one buyer and a number of different buyers that have viewed the item.

69. The system of claim 64, wherein the adjudication application, when the highest bid is at least one of equal to and greater than the reserve price, automatically awards the item to the high bidder upon termination of the auction.

70. The system of claim 64, wherein the adjudication application, when the highest bid of the plurality of bids is less than the reserve price, one of automatically terminates the auction and automatically continues the auction.

71. The system of claim 70, wherein the adjudication application automatically terminates the auction and awards the item to the high bidder upon termination of the auction.

72. The system of claim 70, wherein the adjudication application automatically continues the auction and maintains the reserve price.

73. The system of claim 72, wherein the adjudication application generates a second electronic message to the high bidder to inform the high bidder that the reserve price is being maintained and to inform the high bidder of their status as the high bidder.

74. The system of claim 73, wherein the adjudication application receives an increased bid from the high bidder in response to the second electronic message, and automatically awards the item to the high bidder upon termination of the auction.

75. The system of claim 73, wherein the second electronic message includes at least one of electronic mail, Short Message Service message, instant message, and automated telephone call.

76. The system of claim 73, wherein the adjudication application, in the absence of a response to the second electronic message from the high bidder, determines whether the auction is closed.

77. The system of claim 73, wherein the adjudication application, in the absence of a response to the second electronic message from the high bidder, determines whether the item is at an end of an auction lifecycle corresponding to the item.

78. The system of claim 64, wherein the adjusted reserve price is less than the reserve price.

79. The system of claim 78, wherein the adjudication application, when the adjusted reserve price is at least one of equal to and less than the highest bid, automatically awards the item to a high bidder corresponding to the highest bid upon termination of the auction.

80. The system of claim 78, wherein the adjudication application receives an increased bid from the high bidder in response to the first electronic message, and when the increased bid is one of equal to and greater than the adjusted reserve price, automatically awards the item to the high bidder upon termination of the auction.

81. The system of claim 80, wherein the second electronic message includes at least one of electronic mail, Short Message Service message, instant message, and automated telephone call.

82. The system of claim 80, wherein the adjudication application, in the absence of a response to the first electronic message from the high bidder, determines whether the auction is closed.

83. The system of claim 80, wherein the adjudication application, in the absence of a response to the first electronic message from the high bidder, determines whether the item is at an end of an auction lifecycle corresponding to the item.

84. The system of claim 64, wherein the determining the reserve price is too high comprises evaluating at least one of a number of times the item has been viewed by at least one buyer, a condition of the item, and a market price of the item.
